(19) United States
(12) Patent Application Publication
(10) Pub. No.: US 2026/0178062 A1
(43) Pub. Date: Jun. 25, 2026

(54) FLUID PROPORTIONING SYSTEM WITH FEEDBACK

(71) Applicant: Unist, Inc., Grand Rapids, MI (US)

(72) Inventors: Timothy J. Bangma, Lowell, MI (US); Jarred M. Felt, Hudsonville, MI (US); Zachary D. De Windt, Grand Rapids, MI (US); Zachary E. Talen, Grand Rapids, MI (US); Charles W. Boelkins, Rockford, MI (US)

(21) Appl. No.: 19/354,999

(22) Filed: Oct. 10, 2025

Related U.S. Application Data
(60) Provisional application No. 63/736,671, filed on Dec. 20, 2024.

(51) Int. Cl. G05D 11/13

(52) U.S. Cl. CPC G05D 11/132

(57) ABSTRACT

A fluid delivery system includes a pump, a pressure sensor, and a controller. The pump is configured to pump fluids from a fluid reservoir. The pressure sensor is configured to measure a fluid pressure level at a fluid inlet of the pump. The fluid is drawn into the pump via the fluid inlet. The controller is configured to receive fluid pressure level measurements from the pressure sensor. The controller is configured to control a flow rate of the pump. The controller is operable to derive whether a pump chamber of the pump is completely filling with each pump cycle at the selected flow rate by comparing the fluid pressure level measurements to a fluid pressure signature for the pump.

### CROSS REFERENCE TO RELATED APPLICATION

The present application claims the benefit of U.S. provisional application Ser. No. 63/736,671 filed Dec. 20, 2024, which is hereby incorporated herein by reference in its entirety.

### FIELD OF THE INVENTION

The present invention is directed to liquid delivery systems, such as lubricant delivery systems that apply concentrated fluids diluted to selected ratios.

### BACKGROUND OF THE INVENTION

Industrial processes often require the reliable and consistent delivery of liquid to an applicator mechanism. Examples of such applications include coating metal with lubricant before cutting or forming processes, applying cleaning agents before and/or after other processing, coating metal with a rust preventative for long term storage, or coating wires with hydrated dry film lubricant useful for downstream processing. Such liquids are often provided to a manufacturing facility in a concentrated form, and then diluted with a diluting agent (e.g., water) to a concentration ratio before use. In many instances, the concentrated liquids delivered to the manufacturing facility work best when diluted to a specific ratio. If the mixture is too rich, concentrate fluid is wasted, if the mixture is too lean, the fluid mixture will not perform its desired function adequately.

### SUMMARY OF THE INVENTION

Embodiments of the present invention provide for a fluid proportioning system configured to deliver fluid (e.g., lubricant) at a selected flow rate such that a selected amount of the fluid is mixed with a selected quantity of diluent to achieve a desired concentration ratio for the fluid for application by an apparatus for metal forming and stamping operations. The fluid proportioning system is configured to detect the pressure of fluid entering a fluid pump such that the flow of fluid can be controlled for a selected quantity of fluid for the desired concentration ratio. The fluid proportioning system includes a pressure sensor used to derive an indication of fluid flow for mixing with the diluent. Using the pressure indications, the fluid proportioning system is configured to detect when the pump chamber(s) is inadequately filling, which would affect the flow rate of the fluid. This allows the fluid proportioning system to deliver a fluid diluted to a selected ratio for a manufacturing process and the ability to indicate when the flow rate of the fluid changes causing the mixture ratio of the diluted fluid to potentially change.

According to one form of the present invention, an exemplary fluid delivery system includes a pump, a pressure sensor, and a controller. The pump is configured to pump fluids from a fluid reservoir. The pressure sensor is configured to measure a fluid pressure level at a fluid inlet of the pump. The fluid is drawn into the pump via the fluid inlet. The controller is configured to receive fluid pressure measurements from the pressure sensor. The controller is configured to control a flow rate of the pump. The controller is operable to derive whether a pump chamber of the pump is completely filling with each pump cycle as defined by a comparison of the fluid pressure measurements to a fluid pressure signature for the pump.

According to another form of the present invention, an exemplary method for monitoring the pumping actions of a pump based upon measured fluid pressure levels includes measuring, with a pressure sensor, a fluid pressure level at a fluid inlet of a pump. A fluid is drawn into the pump via the fluid inlet, and the pump is configured to pump the fluids from a fluid reservoir. A controller is used to control a flow rate of the pump. The controller receives fluid pressure level measurements from the pressure sensor. The method also includes deriving, with the controller, whether a pump chamber of the pump is completely filling with each pump cycle by comparing the fluid pressure measurements to a fluid pressure signature for the pump.

In an aspect of the present invention, the pump is a positive displacement, reciprocating piston pump comprising one or more chambers and associated pistons.

In another aspect of the present invention, the pump is a diaphragm pump. The diaphragm pump utilizes a flexible element to seal off the fluid portion of the pump.

In a further aspect of the present invention, the one or more pistons of the pump are driven with compressed air.

In yet another aspect of the present invention, the one or more pistons of the pump are driven by one of hydraulics, waterpower, motor and cam, motor and crank shaft, and the like.

In another aspect of the present invention, the fluid is one of a cutting, forming or process lubricant, a cleaning solution, a corrosion preventative solution, and a hydrated dry film lubricant.

In a further aspect of the present invention, the fluid is a concentrated liquid.

In yet another aspect of the present invention, the fluid delivery system further comprises a fluid proportioning system. The pump is configured to pump a concentrated fluid to the fluid proportioning system, which is configured to mix the concentrated fluid with a diluent to achieve a desired fluid/diluent concentration ratio.

In another aspect of the present invention, the diluent is water. The fluid proportioning system is configured to receive the diluent from a pressurized diluent source. The controller is configured to select a flow rate of the pump (for the concentrated fluid) as defined by a flow rate of the diluent.

In an aspect of the present invention, the controller is operable to detect an incomplete filling of the pump chamber at the selected flow rate of the pump. The controller is configured to indicate to a user via a graphical user interface when the controller detects that the pump chamber is incompletely filling.

Thus, the exemplary fluid proportioning system provides for a consistent delivery of a concentrated fluid (e.g., cutting, forming, or process lubricants, corrosion preventative solutions, cleaning solutions, or hydrated dry film lubricants, and the like) for dilution with a diluent (e.g., water) at a selected concentration ratio for an industrial use or process. By monitoring the fluid pressure of a fluid line at an inlet to a pump, the operation of the pump can be monitored to determine whether the pump is pumping the fluid at a selected flow rate. An exemplary electronic controller compares measured fluid pressure levels to an expected fluid pressure signature graph to detect whether a pump chamber of the pump is completely filling with each pump cycle.

These and other objects, advantages, purposes and features of the present invention will become apparent upon review of the following specification in conjunction with the drawings.

### BRIEF DESCRIPTION OF THE DRAWINGS

FIG. 1 is a block diagram of an exemplary fluid proportioning system in accordance with an embodiment of the present invention;

FIG. 2 is a block diagram of an exemplary embodiment of the fluid proportioning system of FIG. 1;

FIG. 3 is a block diagram of another exemplary embodiment of the fluid proportioning system of FIG. 1;

FIGS. 4A and 4B are illustrations of an exemplary display panel with fluid delivery information and fluid pump operation feedback in accordance with an embodiment of the present invention;

FIG. 5A is a graph plotting an exemplary fluid pressure signature for a fluid pump in accordance with an embodiment of the present invention;

FIG. 5B is a graph plotting an exemplary piston movement over time for a piston of a fluid pump in accordance with an embodiment of the present invention; and

FIG. 6 is a flow diagram illustrating the steps to a method for monitoring the fluid pressure of a fluid pump to monitor the operation of the fluid pump.

### DETAILED DESCRIPTION OF THE PREFERRED EMBODIMENTS

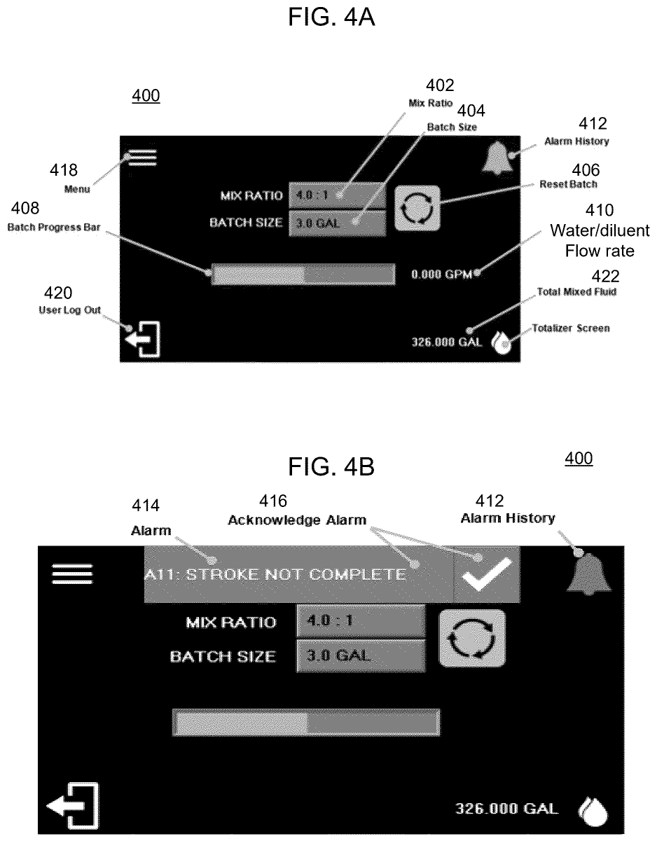

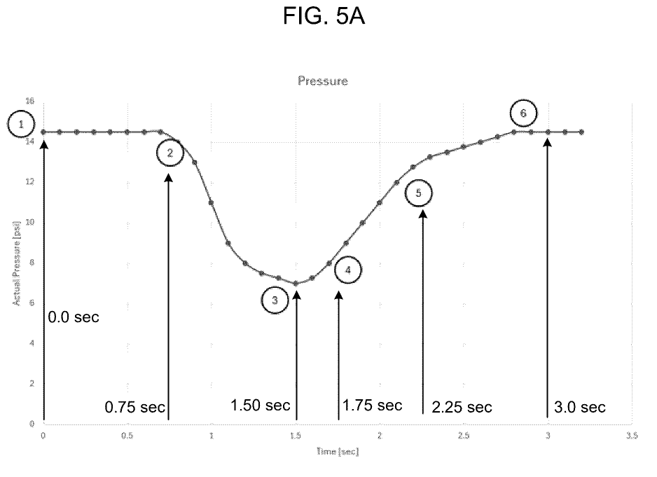

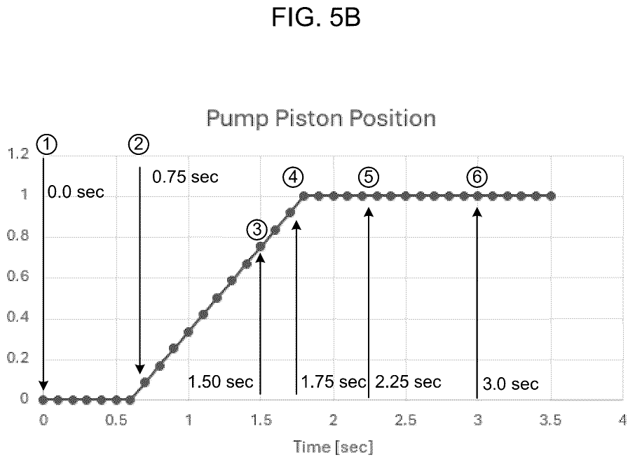

Referring now to the drawings and the illustrative embodiments depicted therein, a fluid proportioning system 100, 200, 300 delivers a concentrated fluid (also referred to as a “concentrate”) for diluting with a diluent (e.g., water) at a selected concentration ratio for an industrial use. By monitoring the fluid pressure of a fluid line coupled to a fluid pump (hereinafter a “pump”), the operation of the pump can be monitored to determine whether the pump is pumping a fluid (e.g., a cutting, forming or process lubricant, a cleaning solution, a corrosion preventative solution, and a hydrated dry film lubricant, and the like) at a selected flow rate. As discussed herein, by monitoring fluid pressure at an intake of a pump 102 of the fluid proportioning system 100, the operation of the pump (delivering a fluid/concentrate at a selected flow rate for mixing with a diluent) can be monitored by an electronic controller 124 to ensure that the fluid/concentrate is diluted to a desired mixture ratio. By comparing a measured pressure level of the fluid/concentrate entering the pump to an expected fluid pressure signature graph (see FIG. 5A), an inadequate filling of the pump's chamber(s) can be detected. When the fluid proportioning system 100, 200, 300 determines that the pump 102 is operating inadequately (and an inadequate quantity of concentrate is being delivered), the electronic controller 124 can respond in a variety of ways. For example, an indication (e.g., via a display 126 or other means) can be provided to a user or operator (see FIGS. 4A and 4B). Alternatively, the electronic controller 124 can provide an indication to other system controllers. In one embodiment, the electronic controller 124 can shut down the pump 102 (and associated valves) or adjust the selected flow rate to correct the incomplete chamber filling of the pump 102. Thus, using a pressure sensor to derive indications of fluid/concentrate flow adequacy (as described herein) is a low-cost alternative to conventional solutions that require the use of an expensive flow meter, and the like, which can be many times more expensive than a fluid pressure sensor.

Thus, exemplary embodiments of the fluid proportioning system 100 can detect whether a concentrate is being adequately delivered for mixture with a diluent to achieve a desired mixture ratio. The reliable and consistent delivery of that concentrate for a desired concentration ratio (when mixed with the diluent) is important for ensuring process dependability and longevity. In metal stamping and forming operations, for example, inadequate lubrication supplied (e.g., a concentrate/diluent mixture that is too lean) to a lubrication applicator can lead to parts defects and decreased tool life. Meanwhile, too much lubricant supplied (e.g., a concentrate/diluent mixture that is too rich) is wasteful and can cause safety hazards.

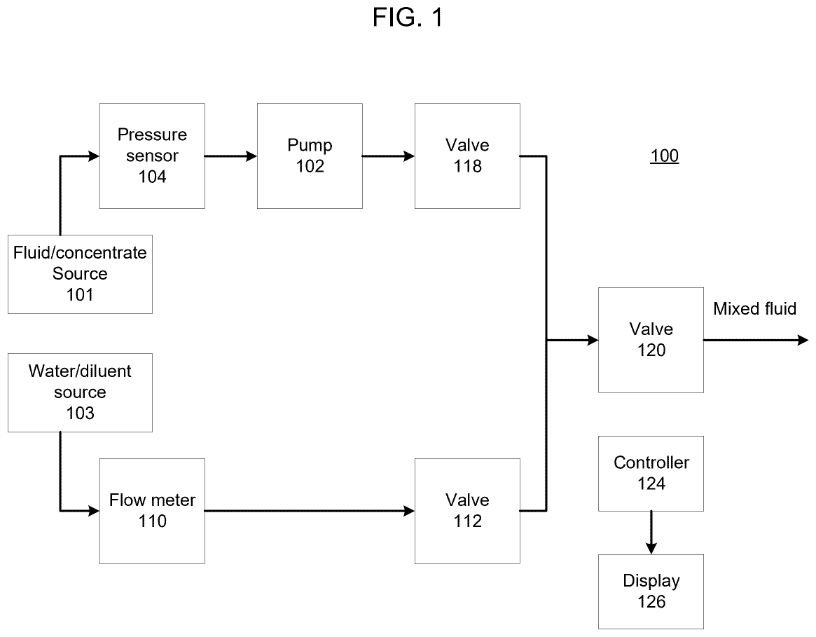

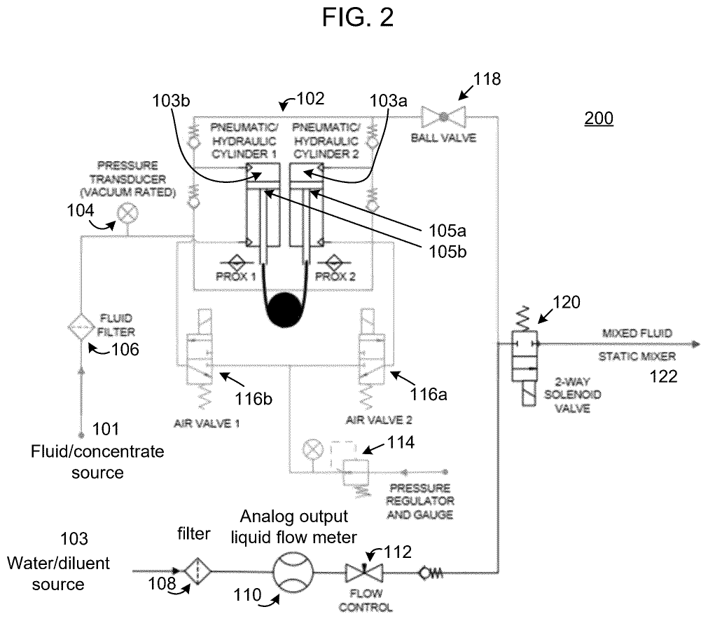

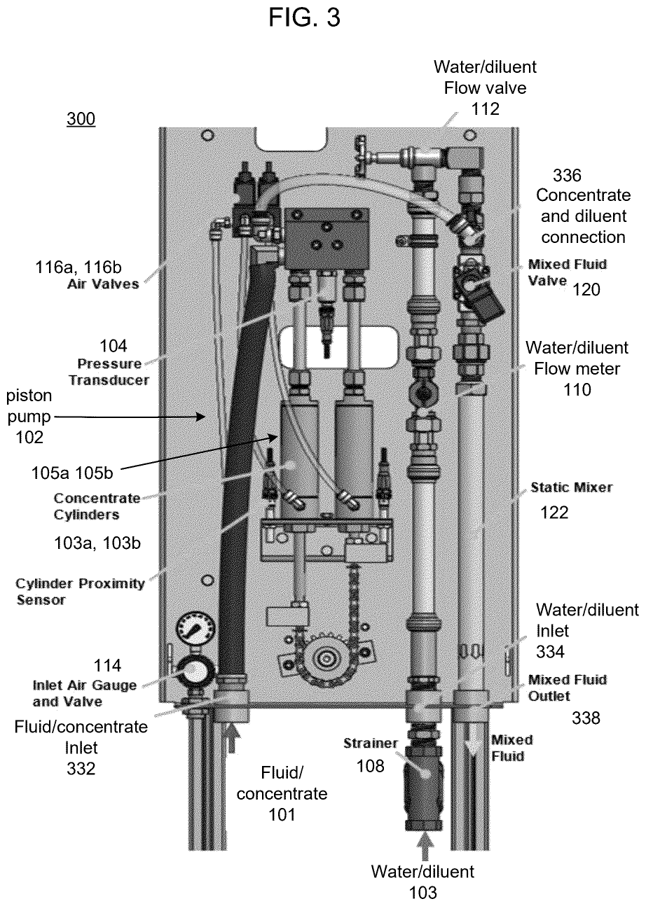

Referring now to FIG. 1, the fluid proportioning system 100 includes a fluid/concentrate source 101 (e.g., a cutting, forming or process lubricant, a cleaning solution, a corrosion preventative solution, and a hydrated dry film lubricant, and the like). Fluid/concentrate from the fluid/concentrate source 101 is pumped by a pump 102. A pressure sensor 104 coupled to the pump 102 (i.e., at an inlet of the pump 102) measures a fluid pressure level of the fluid/concentrate as the fluid/concentrate flows into the pump 102. When a valve 118 downstream from the pump 102 is opened, the fluid/concentrate flows from the pump 102 for mixing with a diluent. As illustrated in FIG. 1, a water/diluent source 103 provides water/diluent through a flow meter 110 and valve 112 for mixing with the concentrate. In one embodiment, the water/diluent source 103 provides pressurized water/diluent (which is monitored via the flow meter 110 for a selected flow rate via the valve 112). When valve 120 is opened, a mixture of the fluid/concentrate and the water/diluent is present in a static mixer 122 (see FIGS. 2 and 3).

The flow meter 110 monitors the flow rate of the water/diluent and outputs a flow rate measurement to the electronic controller 124. Receiving this flow rate measurement, the electronic controller 124 calculates an amount of concentrate (e.g., from the fluid/concentrate source 101) to be added to the water/diluent to achieve a desired mixture ratio (e.g., five (5) parts water/diluent to one (1) part fluid/concentrate). By adjusting the flow rate of the water/diluent and/or the flow rate of the fluid/concentrate, a desired mixture ratio can be achieved. As discussed herein, by monitoring the fluid pressure level of the fluid/concentrate flowing into the pump 102, proper operation of the pump 102 can be monitored.

Likewise, referring to FIG. 2, pressurized diluent (e.g., from water source 103) is filtered via filter 108 and provided for mixing at a selected flow rate (via a flow control 112 and a flow meter 110). A fluid/concentrate (e.g., from fluid source 101) is drawn into the pump 102. As illustrated in FIG. 2, the concentrate flows through a filter 106 and a pressure transducer 104 before entering the pump 102. When ball valve 118 is opened, the concentrate is allowed to flow for mixing with the diluent. When valve 120 is opened, the diluent and concentrate will mix in the static mixer 122 (see FIG. 3).

Referring to FIGS. 2 and 3 (which illustrate exemplary embodiments of a fluid proportioning system 200, 300), an exemplary pump 102 is a reciprocating piston pump comprising one or more chambers or cylinders (e.g., cylinder/chambers 103a, 103b) and pistons (e.g., pistons 105a, 105b). As illustrated in FIGS. 2 and 3, the piston pump 102 (hereinafter “pump”) is driven with compressed air (e.g., the pistons 105a, 105b are driven via a pressure regulator and gauge 114 and corresponding air valves 116a, 116b for each cylinder or chamber 103a, 103b). In alternative embodiments, the pump 102 is driven by hydraulics, waterpower, motor and cam, motor and crank shaft, or any other means for pushing and pulling a piston. The pump 102 is a positive displacement device that outputs a fixed amount of fluid/concentrate with each pump cycle. This volume of fluid/concentrate is known, so the electronic controller 124 can determine how fast to cycle the pump 102 to achieve the desired mix ratio. The output of the pump 102 is injected into the flowing water/diluent stream, where the fluid/concentrate is mixed in the static mixer 122 and delivered to the point of use.

Piston pumps are well known for dispensing fluids and industrial concentrates; however, they have limitations. When a piston of the pump (e.g., pistons 105a, 105b of pump 102) is drawing fluid/concentrate into a pump chamber (e.g., cylinder/chamber 103a, 103b), the piston speed can limit the amount of fluid/concentrate drawn into the pump chamber as vacuum pressure in the pump chamber draws the fluid/concentrate into the pump chamber. Fluid flow into the pump chamber is limited by the amount of vacuum pressure that can be generated, since low vacuum pressure can lead to cavitation. Thus, even though the piston 105a, 105b has completed its stroke, the fluid/concentrate can still be flowing in, and the pump chamber may not have completely filled before the next pump cycle is initiated. In other words, a fluid flow rate limitation of the pump 102 is related to how fast the fluid/concentrate can flow into the pump chamber 103a, 103b. With thicker (high viscosity) fluids, there is significant resistance to flow. In one exemplary embodiment, if the pump piston is moving rapidly, the maximum amount of vacuum pressure generated is one (1) atmosphere of vacuum pressure. With thick fluids/concentrates and this pressure differential, the pump 102 can complete its full stroke, however, the fluid/concentrate will not yet have filled the pump chamber 103a, 103b due to the resistance to flow. That is, the flow rate of the fluid/concentrate flowing into the pump chamber 103a, 103b is limited by the amount of vacuum pressure that can be generated. Inlet restrictions and fluid viscosity can be factors contributing to a maximum flow rate into such a pump chamber/cylinder (e.g., cylinder/chamber 103a, 103b).

By installing a pressure sensor (e.g., pressure sensor 104) on an inlet of a positive displacement, piston pump (the pump 102), the electronic controller 124 can monitor the pressure levels generated while the fluid/concentrate is filling the pump's cylinder/chamber 103a, 103b. A resulting pressure signature that characterizes the changing fluid pressure levels as the pump's chambers fill will be different for varying fluids/concentrates (such as due to viscosity) and equipment configurations. The pressure level measured at the pump 102 (as compared to the known pressure signature for the pump and the fluid/concentrate its currently pumping) can by analyzed by the electronic controller 124 to determine whether the pump chamber/cylinder 103a, 103b is indeed completely filling with each pump cycle. As discussed herein, in the case of fluid mixing systems, the pump's chamber/cylinder 103a, 103b must be completely filled with each pump cycle to ensure that the desired concentrate/diluent mixture ratio is delivered.

Referring to FIG. 5A, an exemplary fluid pressure signature is illustrated. This exemplary fluid pressure signature is for a particular pump and a particular fluid being pumped. FIG. 5B is a graph illustrating an exemplary piston movement over time (also known as a “piston stroke”) for the pump of FIG. 5A, which can be compared to the fluid pressure signature of FIG. 5A. As illustrated in FIGS. 5A and 5B, there are a plurality of “timepoints” that illustrate the actions taking place within the pump chamber as the vacuum pressure changes. At timepoint “1” (0.0 seconds), the pump 102 is idle and the measured pressure is at atmospheric pressure. As illustrated in FIG. 5B, at timepoint “1”, the piston 105a, 105b has not begun its stroke. At timepoint “2” (e.g., 0.75 seconds), the piston 105a, 105b begins to move in the cylinder/chamber 103a, 103b and fluid/concentrate starts getting sucked into the pump cylinder/chamber 103a, 103b. As illustrated in FIG. 5A, the measured pressure at the pump inlet begins to decrease. At timepoint “3” (e.g., 1.5 seconds), the piston 105a, 105b (within the cylinder/chamber 103a, 103b) is still moving, and the measured pressure has reached its minimum. At timepoint “4” (1.75 seconds), the piston 105a, 105b (within the cylinder/chamber 103a, 103b) has completed its stroke (i.e., as illustrated in FIG. 5B, the pump position is at position “1”) and the fluid pressure (at the pump inlet) is starting to rise as fluid/concentrate continues to fill the pump chamber/cylinder 103a, 103b. At timepoint “5” (2.25 seconds), fluid/concentrate is still entering the pump chamber/cylinder 103a, 103b, but the flow rate of the entering fluid/concentrate is slowing as the rate of increase in the pressure slows. At timepoint “6” (3.0 seconds), the pump chamber/cylinder 103a, 103b is now full, and the measured pressure is back where it started at timepoint 1. It is noted that at timepoints “5” and “6”, the piston 105a, 105b remains at position “1” (a full stroke) until the end of the stroke (see FIG. 5B). The electronic controller 124 can compare the initial pressure levels (at the beginning of a pump cycle) to the final pressure levels (at the end of the pump cycle), and/or analyze the rate of change of the increasing pressure levels (in the fluid pressure level signature graph) to determine when the pump's chamber/cylinder 103a, 103b is full. When the exemplary fluid pressure signature (FIG. 5A) is considered with respect to the movement over time of the piston 105a, 105b (FIG. 5B), it can be demonstrated that as the piston 105a, 105b moves in the chamber/cylinder 103a, 103b, the pressure and fluid flow will lag behind that piston movement. Accordingly, the piston 105a, 105b will be expected to not expel the fluid from the chamber/cylinder 103a, 103b (i.e., the piston 105a, 105b will remain at a full stroke position) until the pressure has returned to its expected level (i.e., the chamber/cylinder 103a, 103b is full). If the piston 105a, 105b began moving in the opposite direction to push the fluid out of the chamber/cylinder 103a, 103b before the pressure had returned to its expected level, the desired volume of fluid would not be delivered. Thus, it can be easily seen that if the pump 102 tries to cycle again before the pump pressure has indicated that the pump's cylinder/chamber 103a, 103b is full, the full volume of fluid/concentrate will not be delivered by the pump. That is, the pump cylinder/chamber 103a, 103b will be incompletely filled with each pump piston stroke, resulting in a reduction in the anticipated fluid/concentrate flow rate.

It is noted that while there can be cavitation in a pump chamber (e.g., due to pump speed), the exemplary embodiments of the fluid proportioning system 100 discussed herein are not concerned with cavitation. Rather than monitoring for cavitation, embodiments of the fluid proportioning system 100, 200, 300 ensure that the pump cylinder/chamber 103a, 103b has been fully filled with each pump cycle. Instead of having to rely on precise pump speed controls (e.g., for cavitation prevention due to pump speed), exemplary embodiments employing the techniques described herein make use of readily available and inexpensive components (e.g., pressure sensors) while still providing a high level of monitoring capability to ensure that the fluid proportioning system 100 is delivering fluid/concentrate appropriately.

Referring to FIG. 3, the alternative embodiment of the fluid proportioning system 300 includes many of the same components as the embodiment illustrated in FIG. 2. Fluid/concentrate (e.g., concentrate 101) is delivered to a concentrate fluid inlet 330, while pressurized diluent (e.g., water 103) is delivered to a water inlet 334. Note that the entering diluent/water is filtered with a strainer 108. As illustrated in FIG. 3, the exemplary fluid proportioning system 300 includes a pump 102 that is configured as a positive displacement piston pump that comprises a pair of cylinders/chambers 103a, 103b. The cylinders/chambers 103a, 103b are actuated with pressurized air, which is supplied via an inlet air gauge and valve 114 to the pair of cylinders/chambers 103a, 103b (via air valves 116a, 116b). Fluid/concentrate flowing from the pump 102 was mixed with the diluent/water via the concentrate and water connection 330. When the mixed fluid valve 120 is opened, the mixed concentrate and diluent will enter the static mixer 122 and exit the fluid proportioning system 110b via a mixed fluid outlet 338.

Referring to FIGS. 4A and 4B, an exemplary display panel 400 comprises a series of display fields that are configured to display relevant data. For example, a mix ratio field 402 displays the current mix ratio (e.g., 4.0:1), a batch size field 404 displays the current selected quantity of mix to be delivered (e.g., 3.0 gallons), while a water/diluent flow rate field 410 indicates the current water/diluent flow rate (upon which the need fluid/concentrate flow rate will be based). A reset button 406 can be used to reset the mix ratio and batch size fields. An exemplary progress bar field 408 provides a graphic illustration of the batch completion progress (e.g., the progress bar field 408 is illustrated as indicating the batch size is half completed). A total mixed fluid field 422 displays a total quantity of concentrate/diluent mixture already dispensed (e.g., 326 gallons). An alarm history field 412 and an alarm field 414 (with alarm acknowledge button 416) illustrate a particular alarm: “stroke not complete” (see FIG. 4B). The display panel 400 also includes an exemplary interactive menu 418 and a user log out button 420 for the current user to log in/out and/or interact with the system.

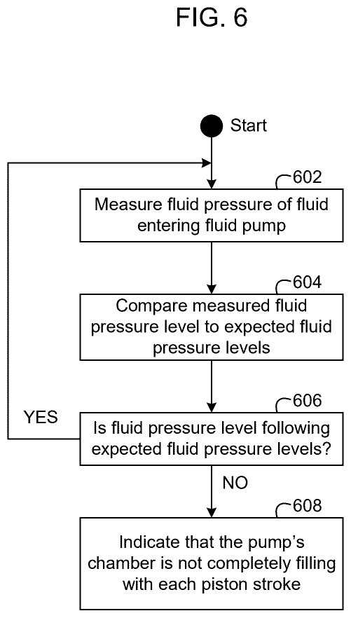

Referring to FIG. 6, an exemplary method for monitoring the performance of a fluid pump (e.g., pump 102) begins in step 602 of FIG. 6 with a measurement of the pressure level of fluid entering the pump. In step 604 of FIG. 6, the measured fluid pressure level is compared to expected pressure levels. For example, a current pressure level while the pump's cylinder/chamber is drawing fluid is compared to an expected fluid pressure level. Such an expected fluid pressure level can be displayed as a fluid pressure signature that illustrates the changing inlet pressure levels to the pump as the pump's piston 105a, 105b cycles within the cylinder/chamber 103a, 103b. In step 606 of FIG. 6, a determination is made as to whether the current fluid pressure level is following the expected fluid pressure levels (e.g., over time, is the measured fluid pressure level falling and rising as expected by the pump's exemplary fluid pressure signature)? If not, the method continues to step 608 of FIG. 6, and an indication that the pump's cylinder or chamber is not completely filling is issued. If the measured pressure is following the expected pressure levels, then the method continues back to step 602, and the fluid pressure continues to be monitored and analyzed.

While the exemplary embodiments (100, 200, 300) have been discussed with respect to pumping a concentrated fluid for mixing with a diluent, the techniques discussed with respect to monitoring a pump's ability to completely fill a pump chamber with each pump cycle to maintain an expected fluid/concentrate flow can be broadly applied to a similar pump pumping any fluid for any purpose. That is, the operation of an exemplary pump (and its ability to completely fill a pump chamber with each pump cycle) can be evaluated by monitoring the fluid pressure of a fluid entering an inlet of the pump. Measured fluid pressure levels (from an exemplary fluid pressure sensor) can be compared to an expected fluid pressure signature graph. Thus, regardless of the use of the fluid pumped by the pump, by monitoring the inlet fluid pressure at the pump, the pump's ability to completely fill a pump chamber with each pump cycle, and thereby properly maintain a desired flow rate can be evaluated.

It is also understood that any style of reciprocating piston, positive displacement pump could benefit from the fluid proportioning systems described herein if used in a mixing or dispensing system (e.g., fluid proportioning systems 100, 200, 300). Such a pump could be driven by hydraulics, waterpower, motor and cam, motor and crank shaft, or any other means for pushing and pulling a piston (e.g., pistons 105a, 105b) through a pump chamber (e.g., cylinder/chamber 103a, 103b). While the exemplary pump 102 is a double acting piston pump with check values to control the flow, a single acting cylinder pump could also be used and benefit from the techniques or methods for detecting a full stroke of fluid in a pump chamber. In an alternative to a reciprocating piston pump with sliding seals, a diaphragm pump could be used. In such an embodiment, an exemplary diaphragm pump utilizes a flexible element (i.e., a diaphragm) to seal off the fluid portion of the pump. A reciprocating action of the flexible element of the diaphragm pump can be used to create a pressure differential (between the two sides of the flexible element) to move fluid through the diaphragm pump. In one embodiment, an exemplary diaphragm pump includes a chamber which is divided in two by the flexible element. Such a diaphragm pump could include one or more valves (e.g., a valve on either side of the diaphragm pump) for controlling fluid flow through the diaphragm pump. Thus, it is contemplated that a variety of different pump embodiments could be utilized with the pressure monitoring technique described herein. While the exemplary embodiments discussed herein pull fluid/concentrate into the pump with suction from a fluid/concentrate reservoir (e.g., fluid source 101), a system with a pressurized fluid/concentrate source could also benefit.

Thus, the exemplary fluid proportioning systems provide for a consistent delivery of a concentrated fluid (e.g., cutting, forming or process lubricants, cleaning solutions, corrosion preventative solutions, and hydrated dry film lubricants, and the like.) for dilution with a diluent (e.g., water) at a selected concentration ratio for an industrial use or process. By monitoring the fluid pressure of a fluid line at an inlet to a pump, the operation of the pump can be monitored to determine whether the pump is pumping the fluid at a selected flow rate. An exemplary electronic controller compares measured fluid pressure levels to an expected fluid pressure signature graph to detect whether a pump chamber of the pump is completely filling with each pump cycle.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. Therefore, it will be appreciated that changes and modifications in the specifically described embodiments can be carried out without departing from the principles of the present invention which is intended to be limited only by the scope of the appended claims, as interpreted according to the principles of patent law including the doctrine of equivalents.

1. A fluid delivery system comprising:
a pump configured to pump fluids from a fluid reservoir;
a pressure sensor configured to measure a fluid pressure level at a fluid inlet of the pump, wherein the fluid is drawn into the pump via the fluid inlet; and
a controller configured to receive fluid pressure level measurements from the pressure sensor, wherein the controller is configured to control a flow rate of the pump;
wherein the controller is operable to derive whether a pump chamber of the pump is completely filling with each pump cycle by comparing the fluid pressure level measurements to a fluid pressure signature for the pump.

2. The fluid delivery system of claim 1, wherein the pump is a positive displacement, reciprocating piston pump comprising one or more chambers and associated pistons.

3. The fluid delivery system of claim 2, wherein the one or more pistons of the pump are driven with compressed air.

4. The fluid delivery system of claim 2, wherein the one or more pistons of the pump are driven by one of hydraulics, waterpower, motor and cam, and motor and crank shaft.

5. The fluid delivery system of claim 1, wherein the fluid is one of a cutting, a forming or process lubricant, a cleaning solution, a corrosion preventative solution, and a hydrated dry film lubricant.

6. The fluid delivery system of claim 5, wherein the fluid is a concentrated liquid.

7. The fluid delivery system of claim 6 further comprising a fluid proportioning system, wherein the pump is configured to pump the fluid to the fluid proportioning system, which is configured to mix the fluid with a diluent to achieve a desired fluid/diluent concentration ratio.

8. The fluid delivery system of claim 7, wherein the diluent is water.

9. The fluid delivery system of claim 7, wherein the fluid proportioning system is configured to receive the diluent from a pressurized diluent source, and wherein the controller is configured to select a flow rate of the pump as defined by a flow rate of the diluent.

10. The fluid delivery system of claim 9, wherein the controller is operable to detect an incomplete filling of the pump chamber at the selected flow rate of the pump.

11. The fluid delivery system of claim 1, wherein the controller is configured to indicate to a user via a graphical user interface when the controller derives that the pump chamber is incompletely filling at the selected flow rate of the pump.

12. A method for monitoring the pumping actions of a pump based upon measured fluid pressure levels, the method comprising:
measuring, with a pressure sensor, a fluid pressure level at a fluid inlet of a pump, wherein a fluid is drawn into the pump via the fluid inlet, and wherein the pump is configured to pump the fluids from a fluid reservoir;
controlling, with a controller, a flow rate of the pump;
receiving, at the controller, fluid pressure level measurements from the pressure sensor; and
deriving, with the controller, whether a pump chamber of the pump is completely filling with each pump cycle by comparing the fluid pressure measurements to a fluid pressure signature for the pump.

13. The method of claim 12, wherein the pump is a positive displacement, reciprocating piston pump comprising one or more chambers and associated pistons.

14. The method of claim 13, wherein the one or more pistons of the pump are driven with compressed air.

15. The method of claim 13, wherein the one or more pistons of the pump are driven by one of hydraulics, waterpower, motor and cam, and motor and crank shaft.

16. The method of claim 12, wherein the fluid is one of a cutting, a forming or process lubricant, a cleaning solution, a corrosion preventative solution, and a hydrated dry film lubricant.

17. The method of claim 15, wherein the fluid is a concentrated liquid, and the method further comprising a fluid proportioning system, wherein the pump pumps the fluid to the fluid proportioning system, which mixes the fluid with a diluent to achieve a desired fluid/diluent concentration ratio, and wherein the diluent is water.

18. The method of claim 17, wherein the fluid proportioning system receives the diluent from a pressurized diluent source, and wherein the controller selects a flow rate of the pump as defined by a flow rate of the diluent.

19. The method of claim 18, wherein the controller is configured to detect an incomplete filling of the pump chamber at the selected flow rate of the pump.

20. The method of claim 12 further comprising indicating to a user via a graphical user interface when the controller derives that the pump chamber is incompletely filling at the selected flow rate of the pump.
